(19) United States
(12) Patent Application Publication
(10) Pub. No.: US 2009/0055308 A1
(43) Pub. Date: Feb. 26, 2009

(54) Multiple Asset Secured Umbrella Loan/Credit Product and Method

(75) Inventors: Debashis Ghosh, Charlotte, NC (US); Sudeshna Banerjee, Waxhaw, NC (US); Kurt Newman, Matthews, NC (US); Thayer Allison, Charlotte, NC (US); Timothy Bendel, Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 11/842,368

(22) Filed: Aug. 21, 2007

(51) Int. Cl. G06Q 40/00

(52) U.S. Cl. 705/38

(57) ABSTRACT

A customer-oriented loan or credit product that allows separate multiple assets to be used as collateral in a single lending product such as a loan (for example, a home equity loan) or a line of credit (for example, a home equity line of credit).

### BACKGROUND

Currently, the underwriting process focuses heavily on the collateral and less on the customer. Loan decisions and servicing are performed, and risks are managed, at the product level. The customer does not have the ability to consolidate multiple equity loans or multiple assets under one lending product.

### SUMMARY

There is a need for a more customer-oriented loan or credit product that allows separate multiple assets to be used as collateral in a single lending product such as a loan (for example, a home equity loan) or a line of credit (for example, a home equity line of credit).

These and other aspects of the disclosure will be apparent upon consideration of the following detailed description of illustrative aspects.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 is a diagram symbolizing a single-asset line of credit product that focuses heavily on the collateral as opposed to the customer.

FIG. 2 is a diagram illustratively symbolizing a multiple-asset line of credit or loan product.

FIG. 3 is a diagram showing an illustrative consolidation of multiple existing lending products into a single umbrella lending product.

FIG. 4 is a diagram showing an illustrative creation of a single umbrella lending product backed by multiple different collateral assets.

FIG. 5 is a functional block diagram of an illustrative system that may be used to manage a multiple-asset umbrella lending product.

FIG. 6 is a flow chart of an illustrative method for managing a multiple-asset umbrella lending product.

### DETAILED DESCRIPTION

The various aspects described herein may be embodied in various forms. The following description shows by way of illustration various examples in which the aspects may be practiced. It is understood that other examples may be utilized, and that structural and functional modifications may be made, without departing from the scope of the present disclosure.

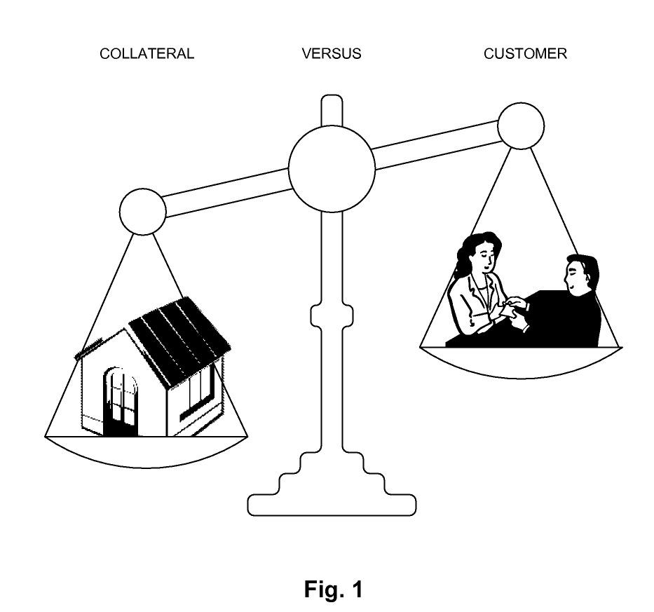

Conventional loan products weigh heavily on the collateral and less on the customer, as represented in FIG. 1. In such a loan product, the collateral asset is underwritten, as opposed to underwriting the customer. Most collateral attributes, such as price, property type, occupancy type, and the like are subjective and thus difficult to pinpoint. Moreover, attributes such as price are typically in flux, making such attributes even trickier to evaluate.

Many types of customer information, on the other hand, are objectively determined and easily available to a financial institution, such as a bank or other lender. For instance, loan default history and prepayment behavior is driven at the customer level and may be detected from insight into historical customer transactions. In many cases, useful customer information is pre-mined and ready for financial institution use.

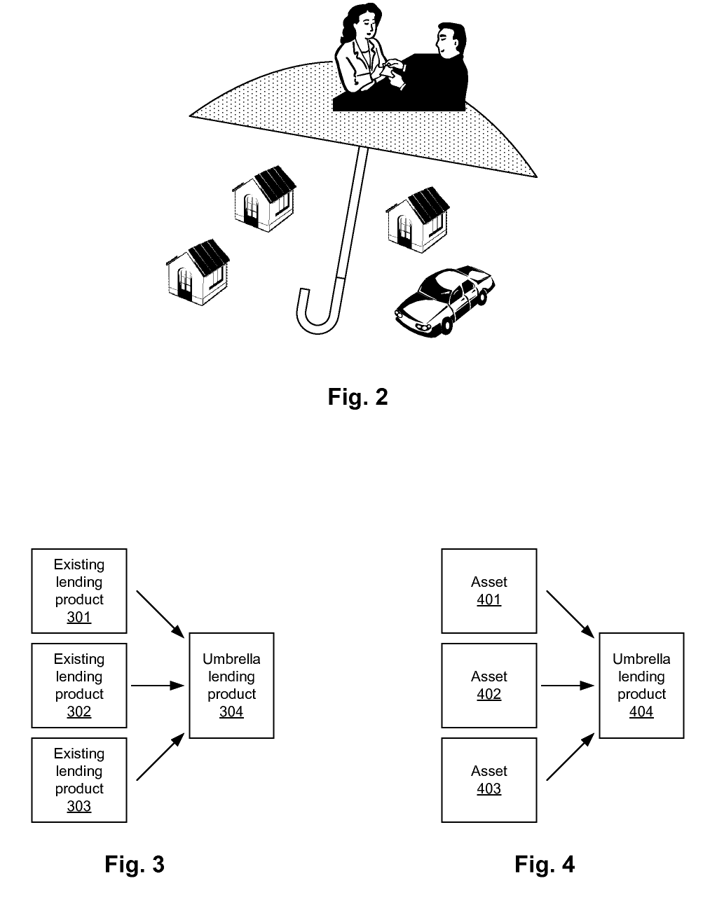

Various illustrative embodiments of an umbrella equity hybrid product will be described herein that allow the financial institution to underwrite the customer itself, as opposed to or in addition to underwriting the collateral asset(s) applied to the product. Such a product may provide a unique opportunity for a financial institution to, for example, wrap up multiple loans for a customer under one “umbrella” product, as represented in FIG. 2.

Underwriting the customer may lead to a variety of potential advantages for both the financial institution and the customer. For example, the customer may find it much easier to use such an umbrella product, because one line to draw from, or other loan, may be provided for multiple collateral assets, as opposed to having to deal with multiple lines or other loans. Moreover, the customer may be able to qualify for lower lending rates based on a differentiated risk-based pricing approach, which will be discussed further below. The financial institution may additionally realize benefits such as enhanced customer retention (due to positive customer experience compared with financial institutions not offering such an umbrella product), and lower servicing costs due to consolidation of what would otherwise be separately managed lending products.

In addition, customer “stickiness” may be created in that it is likely more difficult to lose a larger consolidated lending product to a competitor as opposed to a single smaller lending product. And, because the financial institution is now more focused on the customer than before, the financial institution may more easily track customer-level behavior (such as behaviors associated with impending loan default), thereby providing the basis for an early warning detection system to warn in advance against potential default problems.

Referring to FIG. 3, an umbrella lending product 304 may be formed by consolidating multiple existing lending products 301, 302, 303. For example, lending products 301-303 may be three separate home equity lines of credit or three separate home equity loans. As a particular example, lending product 301 may be a home equity line of credit of $20,000, lending product 302 may be a home equity line of credit of $30,000, and lending product 303 may be a home equity line of credit of $40,000. Now, however, the customer may be able to consolidate these lines of credit into a single umbrella line of credit of $90,000 secured by the three homes previously securing the individual lines of credit. It is noted that lending products 301-303 may be any one or more types of lending product, such as a non-collateralized lending product (e.g., a personal loan). Also, while three lending products are illustratively shown in FIG. 3, any number of existing individual lending products may be consolidated into a single umbrella lending product, such as two, three, four, or more existing individual lending products.

Referring to FIG. 4, an umbrella lending product 305 may alternatively be created without consolidating existing lending products. In this example, umbrella lending product 305 is created and is collateralized with three different assets 401, 402, 403. Assets 401-403 may be the same type of asset or different types of assets. For example, each of assets 401-403 may be a home, an undeveloped lot, a vehicle, a boat, etc. The assets may be cash assets, non-cash tangible assets, or a mixture thereof. In both of the examples of FIGS. 3 and 4, the umbrella lending product may be provided as any type of collateralized lending product desired, such as an umbrella line of credit (e.g., an umbrella home equity line of credit) or an umbrella straight loan (e.g., an umbrella home equity loan). Also, while three assets are illustratively shown as being consolidated in FIG. 4, any number of assets may be consolidated into a single umbrella lending product, such as two, three, four, or more assets.

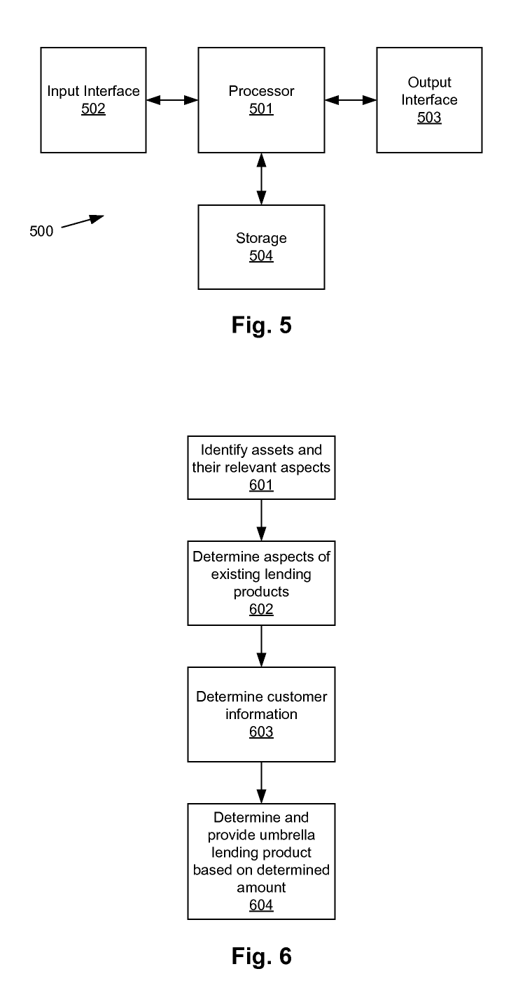

FIG. 5 is a functional block diagram of an illustrative system 500 for managing umbrella lending products. System 500 as shown includes a processor 501, an input interface 502, an output interface 503, and storage 504. Processor 501 may be any type of device capable of processing data, such as but not limited to a computer, a central processing unit (CPU), and/or the like.

Input interface 502 may be configured to receive data originating from outside system 500 for forwarding to processor 501. The data may be forwarded directly or may be pre-processed by input interface 502 before sending to processor 501.

Input interface 502 may include, for instance, one or more user input devices such as a keyboard, a mouse, a touch-sensitive screen, and the like. Input interface 502 may further include, for instance, one or more communication devices such as a network interface receiver (e.g., for receiving data from a network such as the Internet or the intranet of the financial institution).

Output interface 503 may be configured to receive data from processor 501 for sending outside system 500. The data may be forwarded directly or may be pre-processed by output interface 503 before sending outside system 500. Output interface 503 may include, for instance, one or more user output devices such as a monitor, an audio speaker, a printer, and the like. Output interface 503 may further include, for instance, one or more communication devices such as a network interface transmitter (e.g., for sending data to a network such as the Internet or the intranet of the financial institution).

Storage 504 may include one or more computer-readable media for storing computer-executable instructions and/or data. Non-limiting examples of a computer-readable medium include a magnetic disk, an optical disk, a magnetic tape, and memory. Storage 504 may also include a device for reading from and/or writing to the computer-readable media, such as a hard drive, a floppy disk drive, a CD ROM drive, or a tape drive. The computer-executable instructions may be in the form of software that processor 501 reads and executes. The data may represent information regarding one or more umbrella lending product, conventional lending products, assets, and/or customer information. Customer information stored by storage 504 may include, for example, information about customer transactions with the financial institution and/or outside of the financial institution, and/or profile information (e.g., customer name, demographics, address, credit risk such as FICO credit score, financial transaction history, marital status, income, net worth, default history, and/or other customer attributes).

In operation, system 500 may be used by a human user to perform a variety of functions, such as retrieving customer information and/or lending product information, generating customer information and/or lending product information, determining properties of an umbrella lending product, and managing umbrella lending products.

For example, an illustrative method is depicted in FIG. 6 that may be performed using system 500. Some or all of the steps in FIG. 6 may be performed by processor 501, and software stored in storage 504 may include computer-executable instructions that instruct processor 501 to perform these steps.

In FIG. 6, it will be assumed that an umbrella lending product is either being created from scratch and secured by a plurality of different assets, or being created as a consolidation of multiple existing lending products each secured by a different single asset. For example, it will be assumed for purposes of explanation that there are three assets: Home A, Home B, and Home C. However, the assets may be any type of intangible cash assets (such as but not limited to existing investments or account balances) and/or the asset may be of any type of tangible assets, such as but not limited to homes, undeveloped lots (e.g., lots upon which no human-habitable buildings are located), developed lots, any other real estate interests, vehicles, boats, planes, and/or antiques and other valuable collectibles.

In step 601, these assets may be identified by a human user and/or by processor 501. Data representing these assets may be provided to processor 501 via input interface 502 and/or from storage 504, if it has been pre-stored. The data may, for example, provide information about each asset such as a name or other identifier, the value of the asset, the price paid for the asset, the location of the asset, the type of the asset, and/or the ownership of the asset.

The data may further represent or otherwise allow to be determined the equity of ownership in the assets. In addition, any other relevant information about the assets may be determined as desired.

In step 602, information about any existing lending products secured by the assets may be determined by a human user and/or by processor 501. Again, data representing this information may be provided to processor 501 via input interface 502 and/or from storage 504, if it has been pre-stored. This information may include, for example, the loan-to-value (LTV) ratio of a lending product, the type of the lending product, the amount owed under the lending product, the time remaining to pay off the loan, any credit line limit, and/or an identification of the lender.

In step 603, relevant customer information may be determined by a human user and/or by processor 501. As before, data representing this information may be provided to processor 501 via input interface 502 and/or from storage 504, if it has been pre-stored. The customer information may include, for example, the customer information discussed previously.

In step 604, processor 501 and/or a human user choose an appropriate umbrella lending product for the particular situation. This choice may be based on the information determined in any or all of steps 601-603.

For example, the information shown in Table 1 below may have been gathered in steps 601-603. In this example, processor 501 and/or a human user may analyze relevant data for assets Home A, Home B, and Home C, such as the value of each asset, the loan-to-value ratio of the lending product secured by each asset, customer the equity in each asset, and the location of each asset. Other factors as determined steps 601-603 may be considered relevant as well.

TABLE 1

| Asset | Value | Loan-to-Value | Equity | Location |
|---|---|---|---|---|
| Home A | $200,000 | 80% | $15,000 | Charleston, SC |
| Home B | $500,000 | 75% | $50,000 | San Diego, CA |
| Home C | $250,000 | 70% | $20,000 | San Diego, CA |
| TOTAL | $950,000 | 74.7% | $85,000 | |

In this example, the information shown in Table 1 for assets Home A, Home B, and Home C may be used to determine, for the combined assets, a total value, a combined loan-to-value ratio, and a total equity. These total values may also be helpful in determining the aspects of the umbrella lending product. For example, if the combined loan-to-value ratio is high, then a higher interest rate may be more appropriate for the umbrella lending product, or alternatively it may even be decided that such a high loan-to-value ratio would not qualify for an umbrella lending product.

Other factors that may affect aspects of the umbrella lending product include the location of the asset, such as shown in Table 1. This may be especially true for real estate assets. For instance, some geographical regions may be associated with greater mortgage default, or higher salaries, or greater real estate value gains or losses. Accordingly, such information may be relevant to lending risk and therefore may useful to consider when determining which umbrella lending product to provide.

In general, by combining and considering the information determined in steps 601-603, a balanced customer collateral approach may be used to determine the ultimate aspects of the umbrella lending product as a function of the pooled multiple assets and the customer. This balanced approach may balance both the collateral assets and the attributes of the customer itself.

This balanced approach may make it feasible to provide lending products secured by assets that normally would otherwise not have qualified as collateral assets. For instance, assume that the customer of the example in Table 1 would like to increase the total amount of the credit line available or the total amount of money to be borrowed. In the past, the customer would have supplied a reasonable asset to be used as collateral, such as a home. However, the customer would not typically have been able to use certain assets as collateral, such as undeveloped land (e.g., a lot upon which no human-habitable building sits). While such an asset may have intrinsic value, such loans would be extremely risky and therefore typically not done.

On the other hand, if the customer were instead to pool the undeveloped land with the other assets Home A, Home B, and Home C, the risks inherent to lending money on undeveloped land may be spread out and averaged with the lower risks inherent to lending money on homes. Thus, pooling assets of differing risks may allow one to balance the total risk of a single lending product. In addition, pooling assets as collateral for a single lending product may allow for lending products to be secured by assets that previously would not normally have qualified as collateral, such as undeveloped lots.

Because risk-based pricing may be driven by this balanced risk approach, the financial institution may further be enabled to offer a better interest rate for the umbrella lending product than the customer may otherwise experience with conventional individual lending products.

Moreover, it may be desirable to allow for the customer to add and/or remove assets to and/or from an existing umbrella lending product, without necessarily canceling the existing umbrella lending product, and without necessarily requiring the customer to re-qualify for a new lending product. This addition and removal may be allowed to proceed in a “plug and play” fashion at the request of the customer, whereby adding or removing assets may affect the lending rate, total lending amount, total available credit line, and/or other aspects of the umbrella lending product.

Thus, a new type of lending product has been described with respect to various illustrative embodiments. This new umbrella lending product may create a unique opportunity for a financial institution to attract, develop, and retain customer relationships.

1. A method, comprising:
determining a maximum monetary amount based on equity in a plurality of tangible assets;
determining an amount of money so as to be less than or equal to the maximum monetary amount; and
lending the amount of money.

2. The method of claim 1, further comprising:
storing data representing an amount of money owed; and
updating the data so as to increase the amount of money owed by at least the amount of money lent.

2. The method of claim 1, wherein the plurality of assets comprises a first house.

3. The method of claim 2, wherein the plurality of assets comprises a second house located on a lot separate from a lot on which the first house is located.

4. The method of claim 1, wherein the plurality of assets comprises a lot without a human-habitable building.

5. The method of claim 1, further comprising recalculating the maximum monetary amount based on equity in the plurality of assets and an additional asset.

6. The method of claim 5, wherein recalculating is performed after lending the amount of money.

7. The method of claim 1, further comprising recalculating the maximum monetary amount based on equity in less than the plurality of assets.

8. The method of claim 7, wherein recalculating is performed after lending the amount of money.

9. The method of claim 1, further comprising establishing a loan secured by the plurality of assets, wherein lending comprises lending the amount of money under the loan.

10. The method of claim 1, further comprising establishing a line of credit secured by the plurality of assets, wherein lending comprises lending the amount of money under the line of credit.

11. A method, comprising:
consolidating a plurality of lending products into a single combined lending product, each of the plurality of lending products being secured with a different one of a plurality of assets, the single combined lending product being secured by all of the plurality of assets; and
performing one of lending an amount of money under the combined lending product or receiving a payment under the combined lending product.

12. The method of claim 11, further comprising:
determining a loan-to-value quantity for each of the plurality of assets;
determining a combined loan-to-value quantity based on the plurality of loan-to-value quantities; and
determining a rate of the single combined lending product based on the average loan-to-value quantity.

13. The method of claim 11, further comprising:
determining a loan-to-value quantity for each of the plurality of assets;
determining an average loan-to-value quantity based on the plurality of loan-to-value quantities; and
determining a maximum loan amount of the single combined lending product based on the average loan-to-value quantity.

14. The method of claim 11, wherein the plurality of assets comprises a plurality of homes on different lots.

15. The method of claim 11, wherein the plurality of assets comprises a lot without a human-habitable building.

16. A method, comprising:
establishing a lending product secured by a plurality of tangible assets; and
lending an amount of money under the lending product.

17. The method of claim 16, wherein the plurality of assets comprises a plurality of houses on different lots.

18. The method of claim 16, wherein the plurality of assets comprises a lot without a human-habitable building.

19. The method of claim 16, wherein the lending product is a line of credit.

20. The method of claim 16, wherein the lending product is a loan.
